(19) United States
(12) Patent Application Publication
(10) Pub. No.: US 2009/0305634 A1
(43) Pub. Date: Dec. 10, 2009

(54) Device, Method, Computer Program and Chipset for Facilitating Data Exchange Between Two Piconets

(76) Inventor: Duc Hai Dong Nguyen, Castrop-Rauxel (DE)

Correspondence Address: Locke Lord Bissell & Liddell LLP;Attn: IP Docketing, Three World Financial Center, New York, NY, 10281-2101, US

(21) Appl. No.: 12/227,753

(22) PCT Filed: May 25, 2006
(86) PCT No.: PCT/IB2006/002053

§ 371 Date: Apr. 3, 2009

(30) Foreign Application Priority Data
May 30, 2006 (US) 60803414

(51) Int. Cl. H04B 7/00

(52) U.S. Cl. 455/41.2

(57) ABSTRACT

A low power radio frequency device, comprising: a low power radio frequency transceiver; and a processor operable to control the transceiver to transfer first data between the low power radio frequency device and a further low power radio frequency device using slots allocated according to a predetermined regular schedule, to shift the predetermined regular schedule to free slots previously allocated to transferring first data, and to transfer second data using at least one of the freed slots between the low power radio frequency device and at least one other low power radio frequency device, different to the further low power radio frequency device.

### FIELD OF THE INVENTION

Embodiments of the present invention relate to a low power radio frequency device. In particular, they relate to a low power radio frequency device for use in a Bluetooth® network.

### BACKGROUND TO THE INVENTION

Bluetooth is a short-range wireless technology which may be used to connect portable and/or fixed electronic devices. A Bluetooth network is formed and controlled by a single master device. All of the other devices in the network are known as slaves.

Bluetooth devices transmit and receive in a microwave frequency band at 2.4 GHz. A Bluetooth network operates in a time division duplex fashion, and reduces interference by changing the frequency at which each radio packet is transmitted. A number of separate frequency channels are assigned, each with a bandwidth of 1 MHz, and the frequency typically hops at a rate of 1600 hops/s.

A Bluetooth device transmits and receives data by allocating slots in time. Each slot is allocated a different one of a sequence of hopping frequencies, and has a time period of 625 microseconds. Only a master device can begin transmitting a radio packet aligned with the start of the even numbered slots. Only slave devices can transmit a radio packet (addressed for reception by the master device) aligned with the start of an odd numbered slot. The transmission of a radio packet by a slave device typically follows the reception of a radio packet from the master device.

In certain circumstances a Bluetooth device may reserve slots for a particular use, for instance, for a Synchronous Connection-Oriented (SCO) link. When a Bluetooth device participates in an SCO link, slots are allocated to the SCO link according to a predetermined regular schedule. The slots allocated for the SCO link are determined by three parameters controlled by a master device: an SCO interval, T_{SCO}, an SCO offset, D_{SCO}, and a flag indicating how the first SCO slot is calculated. After the first slot, the allocated SCO slots follow periodically at an interval of T_{SCO}.

A Bluetooth device may operate in a number of networks (piconets), but may only be a master in a single piconet. It may be the case that a Bluetooth device operating in a piconet is unable to exchange data with other Bluetooth devices that are not part of the piconet due to commitments that it has in the piconet. It would be desirable to improve this situation.

### BRIEF DESCRIPTION OF THE INVENTION

According to a first aspect of the present invention, there is provided a low power radio frequency device, comprising: a low power radio frequency transceiver; and a processor operable to control the transceiver to transfer first data between the low power radio frequency device and a further low power radio frequency device using slots allocated according to a predetermined regular schedule, to shift the predetermined regular schedule to free slots previously allocated to transferring first data, and to transfer second data using at least one of the freed slots between the low power radio frequency device and at least one other low power radio frequency device, different to the further low power radio frequency device.

According to a second aspect of the present invention, there is provided a method of transferring data using low power radio frequency communication, comprising the steps of: transferring first data using slots allocated according to a first predetermined regular schedule; time shifting the first predetermined regular schedule to create a second predetermined regular schedule; and transferring second data using at least one slot allocated according to the first predetermined regular schedule but not allocated according to the second predetermined regular schedule.

According to a third aspect of the present invention, there is provided a computer program for use in transferring data using low power radio frequency communication, comprising: means for instructing transfer of first data using slots allocated according to a first predetermined regular schedule; means for instructing the time shifting of the first predetermined regular schedule to create a second predetermined regular schedule; and means for instructing the transfer of second data using at least one slot allocated according to the first predetermined regular schedule but not allocated according to the second predetermined regular schedule.

According to a fourth aspect of the present invention, there is provided a chipset for use in a low power radio frequency device, comprising: circuitry operable to transfer first data using slots allocated according to a first predetermined regular schedule, to time shift the first predetermined regular schedule to create a second predetermined regular schedule, and to transfer second data using at least one slot allocated according to the first predetermined regular schedule but not allocated according to the second predetermined regular schedule.

In embodiments of the present invention, a low power radio frequency (LPRF) device transfers first data with a further LPRF device using slots allocated according to a predetermined regular schedule. The LPRF device is advantageously able to allocate slots more effectively by shifting the predetermined regular schedule to free slots, enabling it to use at least one of the freed slots to transfer second data between the LPRF device and at least one other LPRF device.

Typically, a low power radio frequency device is a device that is operable to transmit signals at a power of 100 mW or less, and/or receive radio signals that have been transmitted at a power of 100 mW or less (corresponding to Power Class 1 of the Bluetooth Specification Version 2.0+ EDR [vol 3]). In particular, some low power radio frequency devices are operable to transmit signals at a power of 2.5 mW or less, and/or receive radio signals that have been transmitted at a power of 2.5 mW or less (corresponding to Power Class 2 of the Bluetooth specification version 2.0+ EDR [vol 3]). Certain low power radio frequency devices are operable to transmit signals at a power of 1 mW or less, and/or receive radio signals that have been transmitted at a power of 1 mW or less (corresponding to Power Class 3 of the Bluetooth specification version 2.0+ EDR [vol 3]).

### BRIEF DESCRIPTION OF THE DRAWINGS

For a better understanding of the present invention, reference will now be made by way of example only to the accompanying drawings in which:

FIG. 1 illustrates a Bluetooth device;

FIG. 2 illustrates two Bluetooth piconets;

FIG. 3 illustrates a method of using a master Bluetooth device to shift slots allocated for the transfer of SCO radio packets to transfer data with another Bluetooth device;

FIG. 4a illustrates first and second slot trains for Bluetooth devices involved in SCO connections in separate piconets;

FIG. 4b illustrates a first way of shifting the slots allocated for the transfer of SCO radio packets in a first piconet;

FIG. 5a illustrates two slot trains for Bluetooth devices involved in SCO connections in separate piconets;

FIG. 5b illustrates a second way of shifting the slots allocated for the transfer of SCO radio packets in a first piconet;

FIG. 6 illustrates a method of using a slave Bluetooth device to initiate the shifting of slots allocated for the transfer of SCO radio packets to transfer data with another Bluetooth device;

FIG. 7a illustrates two slot trains for Bluetooth devices involved in SCO connections in separate piconets; and

FIG. 7b illustrates a third way of shifting slots allocated for the transfer of SCO radio packets in a first piconet.

### DETAILED DESCRIPTION OF EMBODIMENTS OF THE INVENTION

The figures illustrate a low power radio frequency device 10, comprising: a low power radio frequency transceiver 14; and a processor 12 operable to control the transceiver 14 to transfer first data 9 between the low power radio frequency device 10 and a further low power radio frequency device 20 using slots allocated according to a predetermined regular schedule, to shift the predetermined regular schedule to free slots previously allocated to transferring first data 9, and to transfer second data 11 using at least one of the freed slots between the low power radio frequency device 10 and at least one other low power radio frequency device 30, different to the further low power radio frequency device 20.

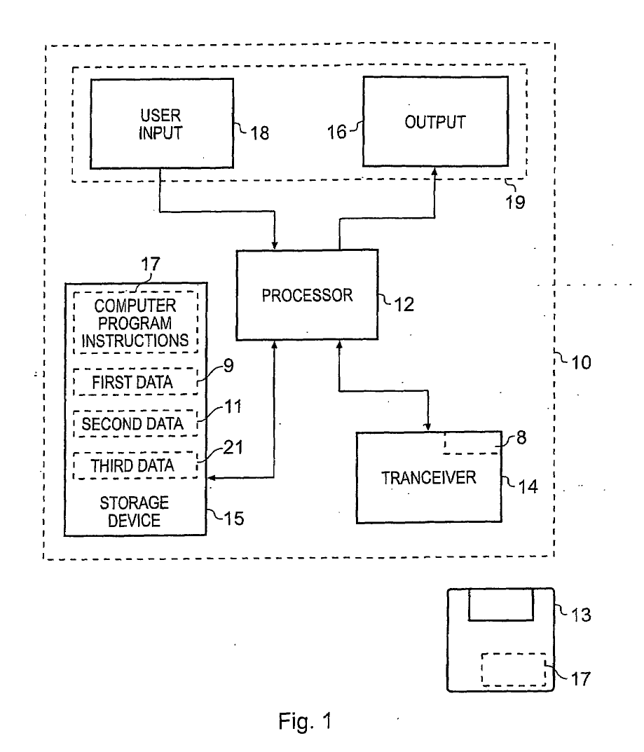

FIG. 1 is a schematic illustration of a low power radio frequency/Bluetooth device 10. It may be fixed in position, or portable. For example, it may be a hand portable device, such as a personal digital assistant (PDA) or a mobile radiotelephone. The Bluetooth device 10 comprises a processor 12, a transceiver 14 (comprising an antenna 8), a storage device 15, an output 16 and a user input 18.

The processor 12 is connected to receive an input from the transceiver 14 and the user input 18, and to provide an output to the transceiver 14 and the output 16. The processor 12 is also connected to write to and read from the storage device 15.

The processor 12 may be, for example, a programmable processor that interprets computer program instructions 17 and processes data. Alternatively, the processor 12 may be, for example, a hardwired, application-specific integrated circuit (ASIC).

The output 16 and the user input 18 together form a user interface 19. The user input 18 may, for instance, comprise a keypad or other device for user input. The output 16 is for conveying information to a user and may, for instance, comprise a display. The output 16 and the input 18 may be combined, for instance, in a touch sensitive display device.

The storage device 15 comprises first data 9, second data 11, third data 21 and computer program instructions 17. The first data 9, the second data 11 and the third data 21 may be for sending to other Bluetooth devices using the transceiver 14, or alternatively, the first data 9, the second data 11 and the third data 21 may have been received from other Bluetooth devices using the transceiver 14.

The storage device 15 may be a single memory unit or a plurality of memory units. If the storage device comprises a plurality of memory units, part or the whole of the computer program instructions 17, the first data 9, the second data 11 and the third data 21 may be stored in the same or different memory units.

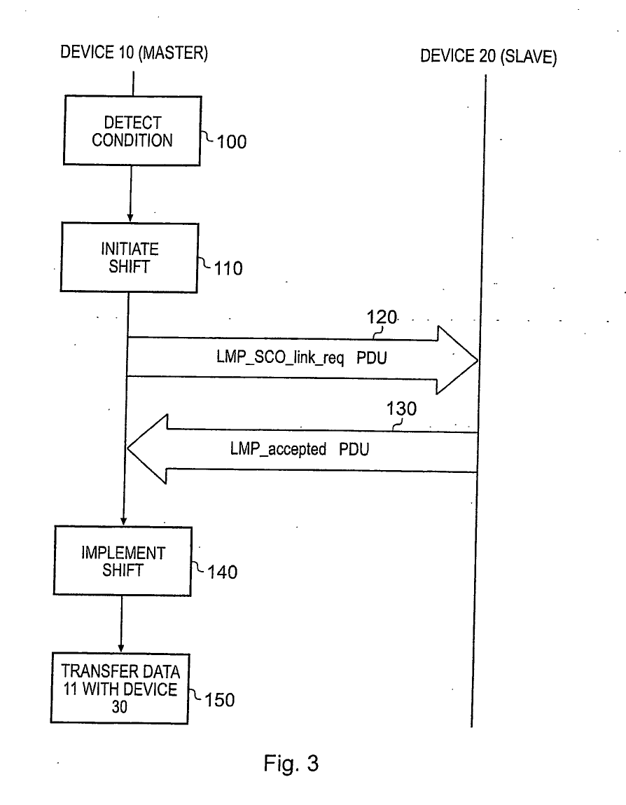

The Bluetooth device 10 illustrated in FIG. 1 is suitable for performing the methods described in relation to FIGS. 3 to 7b. The computer program instructions 17 control the operation of the Bluetooth device 10 when loaded into the processor 12. The computer program instructions 17 provide logic and routines that enable the Bluetooth device 10 to perform the methods illustrated in FIGS. 3 to 7b. The computer program instructions 17 provide: means for instructing the transfer between a low power radio frequency device 10 and a further low power radio frequency device 20 of first data 9 using slots allocated according to a predetermined regular schedule; means for instructing the shifting of the predetermined regular schedule to free slots previously allocated to transferring first data 9; and means for instructing the transfer of second data 11 using the freed slots between the low power radio frequency device 10 and at least one other low power radio frequency device 30, different to the further low power radio frequency device 20.

The computer program instructions 17 may arrive at the Bluetooth device 10 via an electromagnetic carrier signal or be copied from a physical entity 13 such as a computer program product, memory device or a record medium such as a CD-ROM or a DVD. A record medium 13 is illustrated in FIG. 1.

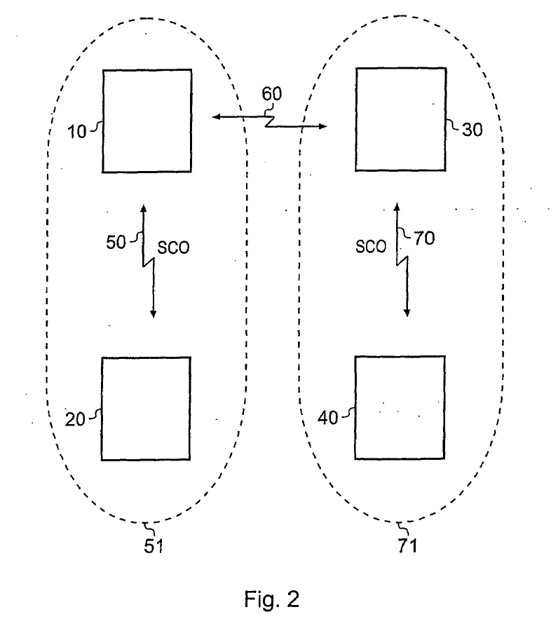

FIG. 2 illustrates a first Bluetooth device 10 and a second Bluetooth device 20 which make up a first Bluetooth piconet 51. The first and second Bluetooth devices 10, 20 exchange data using an SCO link 50. A third Bluetooth device 30 and a fourth Bluetooth device 40 make up a second Bluetooth piconet 71. The third and fourth Bluetooth devices 30, 40 exchange data using a second SCO link 70.

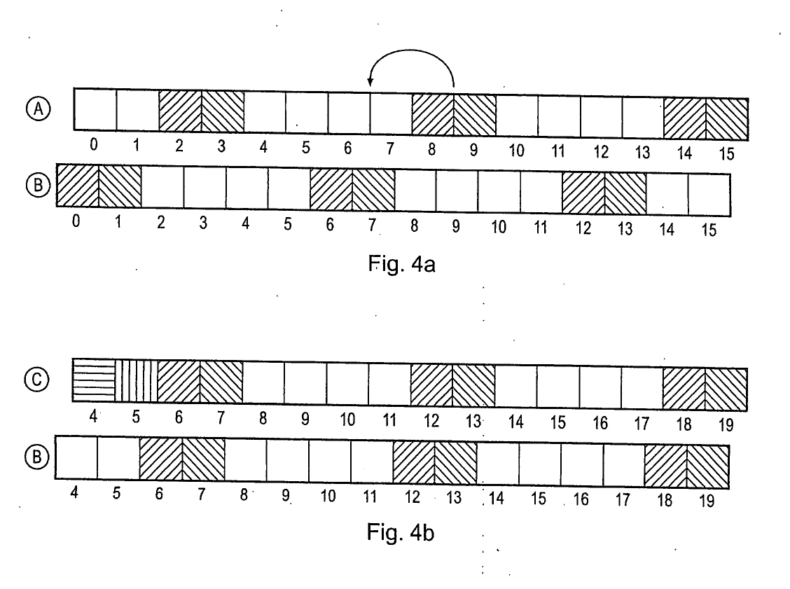

Slot train A in FIG. 4a illustrates how slots are allocated in the first piconet 51. An SCO offset D_{SCO} and an SCO interval T_{SCO} define the SCO link 50 illustrated by slot train A. The SCO link 50 is a HV3 SCO link, so the first and second Bluetooth devices 10, 20 only send SCO radio packets 9 in two out of every six slots (i.e. T_{SCO} is set to 6).

In all of the slot trains illustrated in the figures, the master device transmits in the even numbered slots and a slave device transmits in the odd numbered slots. In slot train A in FIG. 4a, slots 2, 3, 8, 9, 14 and 15 are allocated for transferring SCO data 9 on the SCO link 50 (indicated by diagonal cross hatching). The first and second Bluetooth devices 10, 20 may use the unallocated time, corresponding to free slots 0, 1, 4 to 7 and 10 to 13, to transmit other data to each other or to other Bluetooth devices.

The third and fourth Bluetooth devices 30, 40 are connected using an SCO link 70 in the second piconet 71. Slot train B in FIG. 4a illustrates the allocation of slots in the second piconet 71. The second SCO link 70 in the second piconet 71 is also a HV3 SCO link. Slots 0, 1, 6, 7, 12 and 13 are reserved for transferring SCO data 9 on the second SCO link 70 and the rest of the slot time is free for transferring other data.

In order for the first Bluetooth device 10 or the second Bluetooth device 20 to communicate with the third or-fourth Bluetooth devices 30, 40, free slot space in slot train A must correspond with free slot space in slot train B. As can be seen from FIG. 4a, the arrangement of the slots allocated to the two SCO links 50, 70 mean that two consecutive free slots in slot train A do not correspond with free slot space in slot train B, and two consecutive free slots in slot train B do not correspond with free slot space in slot train A.

Consider a situation in which one of the Bluetooth devices 10, 20 in the first piconet 51 wishes to initiate a connection with one of the Bluetooth devices 30, 40 in the second piconet 71. Particularly, the first Bluetooth device 10 wishes to initiate a connection 60 with the third Bluetooth device 30 by exchanging data 11.

As the first Bluetooth device 10 initiates the connection 60, it becomes (initially) the master of the subsequent connection 60. If the first Bluetooth device 10 is also the master of the first SCO connection 50 and the first piconet 51, the third Bluetooth device 30 will become part of the first piconet 51. Otherwise, a new, third piconet is formed.

There are two main procedures that are used in Bluetooth technology to form a connection: the inquiry procedure and the paging procedure. The inquiry procedure is used to ‘discover’ devices. The paging procedure is used to transfer parameters to and from a device that has already been discovered. Those parameters are then used to form a connection with the device.

Information regarding the inquiry and paging procedures may be found in the Bluetooth specification. The latest version of the Bluetooth specification at the time of writing is Version 2.0+ EDR [vol. 3].

Where the first Bluetooth device 10 wishes to discover the third Bluetooth device 30, it enters the inquiry substate and transmits an inquiry message. Two Inquiry messages per master slot may be transmitted, each at a different frequency in a sequence of predetermined frequencies.

As the first Bluetooth device 10 is the sender of the inquiry message, it will be the master of any connection that results from the transmission of the inquiry message. The inquiry message is not specifically addressed to the third Bluetooth device, and may be received by any Bluetooth device within the range of the first Bluetooth device 10 that is in the inquiry scan substate. If the third Bluetooth device 30 receives the inquiry message, it enters the inquiry response substate and responds to the inquiry message by transmitting an inquiry response message to the first Bluetooth device 10. The process of transmitting and receiving an inquiry message and transmitting and receiving an inquiry response message spans two or three consecutive slots.

When the third Bluetooth device 30 has been discovered by the first Bluetooth device 10 and the first Bluetooth device 10 wishes to connect with the third Bluetooth device 30, the paging procedure may be used. The paging procedure comprises two main parts. In the first part, the first (master) Bluetooth device 10 enters the page substate and transmits a page message to the third (slave) Bluetooth device 30, which is in the page scan substate. Two page messages per master slot may be transmitted, each at a different frequency in a sequence of predetermined frequencies. Upon reception of the page message, the third Bluetooth device 30 enters the page response substate and responds with a page response message. In the second part of the paging procedure, the first Bluetooth device 10 sends an FHS message to the third Bluetooth device 30, which responds with an FHS response message.

The first part of the procedure, transmitting and receiving a page message and transmitting and receiving a page response message, spans two slots. The second part of procedure, transmitting and receiving an FHS message and transmitting and receiving an FHS response message, also spans two slots.

As can be seen in FIG. 4a, allocation of slots for the transfer of SCO data 9 in slot train A of the first piconet 51 and slot train B of the second piconet 71 has been made in such a way that two consecutive free slots in slot train A do not correspond with free slot space in slot train B. It may not therefore be possible to complete the inquiry procedure, the first part of the paging procedure or the second part of the paging procedure.

The first and second Bluetooth devices 10, 20 in the first piconet 50 are unaware of how the slots in the second piconet 70 have been allocated to the second SCO connection 71. Similarly, the third and fourth Bluetooth devices 30, 40 in the second piconet 70 are unaware how the slots in the first piconet 50 have been allocated to the first SCO connection 51.

At step 100 of FIG. 3, the processor 12 of the first Bluetooth device 10 detects a condition which indicates that it has not been possible to exchange data with the third Bluetooth device 30. For instance, the processor 12 of first Bluetooth device 10 may be configured to detect when it has sent inquiry/page messages at some of the frequencies in a sequence of predetermined frequencies without receiving an inquiry/page response message. Alternatively, the processor 12 of the first Bluetooth device 10 may be configured to detect when it has sent inquiry/page messages at each and every frequency in a sequence of predetermined frequencies without receiving an inquiry/page response message. In another embodiment, the first Bluetooth device 10 may be configured to detect when it has sent inquiry/page messages a number of times at each and every frequency in a sequence of predetermined frequencies. In a further embodiment, the processor 12 may be configured to detect when a period of time has elapsed, following the transmission of an inquiry/page message by the first Bluetooth device 10.

Once the processor 12 of the first Bluetooth device 10 has detected a condition at step 100 in FIG. 3, it initiates a shift of the slots that are allocated to transferring SCO data 9 on the SCO link 50 at step 110. The shift may be initiated automatically (i.e. without user intervention) or the processor 12 may instruct the output 16 to provide a prompt to the user, asking him whether he wishes to initiate the shift. The user may respond to the prompt using the user input 18 to initiate the shift.

In this particular embodiment, the first Bluetooth device 10 is a master of the first SCO link 50. To initiate the shift, the first Bluetooth device 10 sends an LMP_SCO_link_req PDU (Protocol Data Unit) 120 to the second (slave) Bluetooth device 20. The LMP_SCO_link_req PDU 120 sent by the first Bluetooth device 10 indicates that it wishes to change the SCO offset, D_{SCO}, by a certain number of slots to change which slots are allocated for the transfer of SCO data 9 in the future. The second Bluetooth device 20 receives the LMP_SCO_link_req PDU 120 and responds by transmitting an LMP_accepted PDU 130 to the first Bluetooth device 10.

After receiving the LMP_accepted PDU 130 from the second Bluetooth device 20, at step 140 of FIG. 3 the processor 12 of the first Bluetooth device 10 implements the shift of the slots allocated to the transfer of SCO data 9 by changing D_{SCO} to the value that it indicated in the LMP_SCO_link_req PDU 120.

FIG. 4b illustrates the slot train for the first and second piconets 51, 71 after the SCO offset for the first SCO link 50 has been changed. Slot train A in FIG. 4a is the slot train for the first piconet 50 before the SCO offset has been changed and slot train C in FIG. 4b is the slot train for the second piconet 70 after the SCO offset has been changed. The LMP_SCO_link_req PDU 120 is transmitted by the first Bluetooth device 10 at slot 4 (indicated by horizontal cross hatching) and the LMP_accepted PDU 130 is transmitted by the second Bluetooth device at slot 5 (indicated by vertical cross hatching).

The effect of changing the SCO offset is to shift the slots allocated to transferring SCO data 9 forwards in time by two slots, so they are sent at an earlier point in time. For example, the SCO data 9 that, according to the schedule shown by slot train A, would have been transferred in slots 8 and 9 is now transferred at slots 6 and 7. The SCO interval, T_{SCO}, remains unchanged so the next portion of SCO data 9 transferred on the first SCO link 50 in slot train C is transferred at slots 12 and 13.

The regular slots allocated to the second SCO link 70 in the second piconet 71 have not been changed, so the SCO data 9 transferred in the first SCO link 50 following the change in SCO offset now overlaps in time with the SCO data sent in second SCO link 70.

Due to the shift in the slots allocated to the transfer of the SCO data 9, there are now more free (available, unallocated) slots in the slot train for the first piconet 50 (slot train C) that correspond to free slot space in the slot train for the second piconet (slot train B). The slots that were previously allocated for the transfer of SCO data 9 between the first Bluetooth device 10 and the second Bluetooth device 20 are freed i.e. made available or are unallocated. These slots and other free slots may now be used to transfer data between the first Bluetooth device 10 and the third Bluetooth device 30.

For instance, the whole of slots 8, 9 and 10 and part of slot 11 of slot train C now correspond with free slot space in slot train B. These slots are available and unallocated. They may now be used for the inquiry procedure or the paging procedure.

Considering the paging procedure, a page message may be sent by the first Bluetooth device 10 to the third Bluetooth device 30 in slot 8 of slot train C. If that page message is received by the third Bluetooth device 30, it may send a page response message to the first Bluetooth device at slot 9.

The second part of the Paging procedure may begin at slot 10. In slot 10, the first Bluetooth device 10 sends an FHS message to the third Bluetooth device 30. If the FHS message is received by the third Bluetooth device 30, it sends an FHS response message to the first Bluetooth device 10 in slot 11. In the event that the third Bluetooth device 30 is unable to transmit the FHS response message in the free slot space corresponding to slot 11 in slot train C because it is committed to send SCO data in the second SCO link 70 in slots 12 and 13 of slot train B, the first Bluetooth device 10 detects that it has not received a response to the FHS message and resends it to the third Bluetooth device in slot 14 of slot train C. The third Bluetooth device 30 responds to the reception of the FHS message by sending an FHS response message to the first Bluetooth device 10 in slot 15 of slot train C.

FIGS. 4a and 4b illustrate the slots allocated for transferring SCO data 9 being shifted forwards by two slots, so that the SCO data 9 is sent earlier in time. Alternatively, it may be that the slots allocated for transferring SCO data 9 are shifted backwards in time by two slots or backwards in time by four slots.

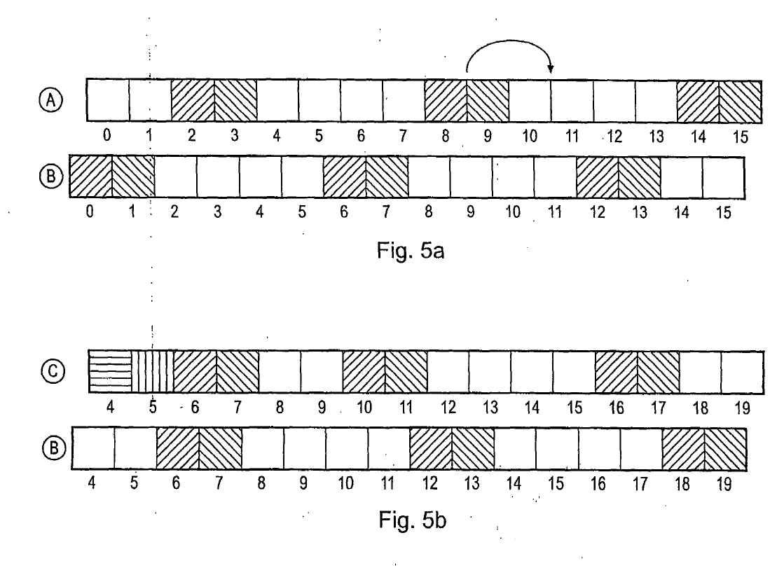

FIGS. 5a and 5b illustrate a situation where the slots allocated for transferring SCO data 9 are shifted backwards in time by two slots, so that they are sent at a later point in time. The SCO data 9 that, according to the schedule shown by slot train A in FIG. 5a, would have been transferred in slots 8 and 9 is transferred in slots 10 and 11 following the change in the SCO offset. The SCO interval, T_{SCO}, remains unchanged so the next portion of SCO data 9 transferred on the first SCO link 50 is transferred at slots 16 and 17, as indicated in slot train C in FIG. 5b.

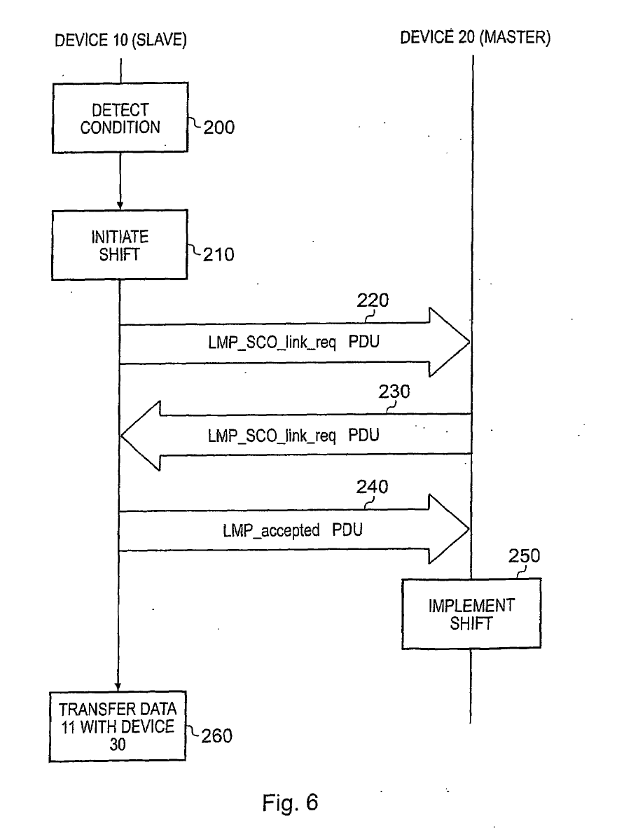

Consider a situation in which the first Bluetooth device 10 wishes to initiate a connection to the third Bluetooth device 30, but is a slave in the first piconet 51 and the first SCO link 50. Here, at step 200 of FIG. 6, the processor 12 of the first Bluetooth device 10 detects a condition which indicates that it has not been possible to exchange data with the third Bluetooth device 30, in the same way that it did in step 100 of FIG. 3.

Referring to FIG. 6, at step 210, the processor 12 initiates a shift of the slots that are allocated to transferring SCO data 9 on the first SCO link 50. The first Bluetooth device 10 transmits a LMP_SCO_link_req PDU 220 to third Bluetooth device 30. The LMP_SCO_link_req PDU 220 indicates that it wishes to change the SCO offset, D_{SCO}, by a certain number of slots to change which slots are allocated to the transfer of SCO data 9 in the future. The second Bluetooth device 20 receives the first LMP_SCO_link_req PDU 220 and responds by transmitting a second LMP_SCO_link_req PDU 230 to the first Bluetooth device 10. The second LMP_SCO_link_req PDU 230 indicates that the SCO offset D_{SCO} is to change to the value that was indicated in the first LMP_SCO_link_req PDU 220.

After receiving the second LMP_SCO_link_req PDU 230, the first Bluetooth device 10 indicates that it accepts the change in the SCO offset D_{SCO} sending a LMP_accepted PDU 240 to the second Bluetooth device 20. The second (master) Bluetooth device 20 then implements the shift of the slots allocated to the transfer of SCO data 9 by changing the SCO offset D_{SCO} to the value indicated in the first and second LMP_SCO_link_req PDUs 220, 230.

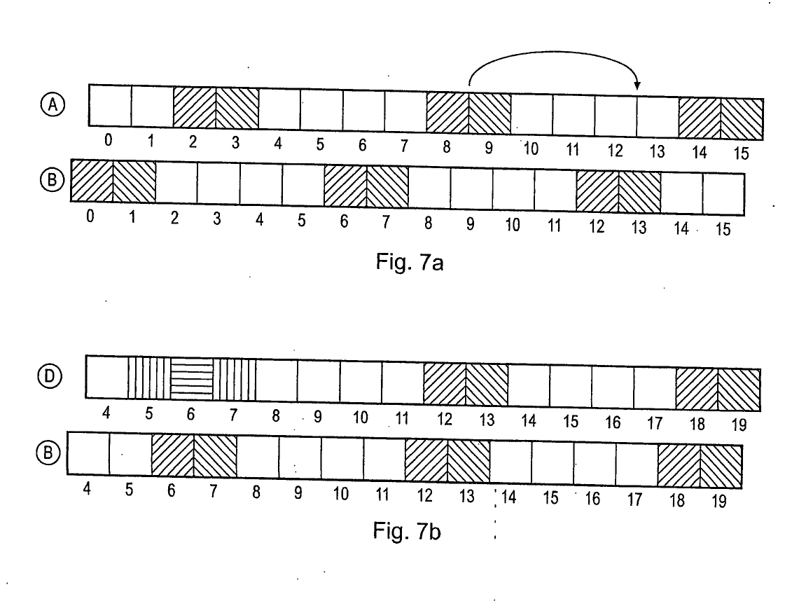

Referring to FIGS. 7a and 7b, the first LMP_SCO_link_req PDU 220 is transmitted in slot 5 of slot train D of FIG. 7b, second LMP_SCO_link_req PDU 230 transmitted in slot 6 and the LMP_accepted PDU 240 is sent in slot 7.

FIGS. 7a and 7b illustrate a situation where the SCO offset D_{SCO} is changed to shift the slots that are allocated to transferring SCO data 9 backwards in time by four slots, so they are sent at a later point in time. For example, the SCO data 9 that, according to the schedule shown by slot train A, would have been transferred in slots 8 and 9 before the change in the SCO offset D_{SCO} is now transferred at slots 12 and 13. The SCO interval, T_{SCO}, remains unchanged so the next portion of SCO data 9 transferred on the first SCO link 50 is transferred at slots 18 and 19, as indicated by slot train D in FIG. 7b.

In the above paragraphs, embodiments of the invention have been described in relation to the first Bluetooth device 10 discovering the third Bluetooth device 30 using the inquiry procedure and initiating a connection to the third Bluetooth device 30 using the paging procedure. However, it may be that first Bluetooth device 10 is being discovered by the third Bluetooth device 30 or the third Bluetooth device 30 is initiating a connection to the first Bluetooth device 10. In other words, the first Bluetooth device 10 is a slave in any subsequent connection between the first Bluetooth device 10 and the third Bluetooth device 30.

In this situation, where the first Bluetooth device 10 is in the inquiry scan substate awaiting an inquiry message or the page scan substate awaiting an inquiry/page message, the processor 12 of first Bluetooth device 10 may be configured to initiate a change in the SCO offset of the first SCO link 50 once it has detected when the first Bluetooth device 10 has scanned for inquiry/page messages at some or all of the frequencies in a sequence of predetermined frequencies without receiving an inquiry/page message. Alternatively, the processor 12 of the first Bluetooth device 10 may be configured to automatically detect when the first Bluetooth device 10 has scanned for inquiry/page messages a number of times at each and every frequency in a sequence of predetermined frequencies without receiving an inquiry/page message.

In a further embodiment, the processor 12 of first Bluetooth device 10 may be configured to initiate a change in the SCO offset of the first SCO link 50 when a period of time has elapsed since the first Bluetooth device 10 began scanning for inquiry/page messages, if the device 10 has not received an inquiry/page message in that time.

In some embodiments of the invention, the processor 12 of the first Bluetooth device 10 is arranged to change the SCO offset periodically, for instance every 1.25 s. Alternatively, the period of time between each change in the SCO offset may be variable, and it may also be randomly selected.

It may be that the processor 12 detects a condition which indicates that it has not been possible to exchange data with the third Bluetooth device 30, and then periodically changes the SCO offset until the first Bluetooth device 10 has exchanged data with the third Bluetooth device 30. The change in the SCO offset may result in the slots that are allocated to transferring SCO data 9 being shifted forwards in time by two slots, or backwards in time by two or four slots. The type of change in SCO offset initiated by the processor 12 may be randomly selected. This means that if the third Bluetooth device 30 is also periodically changing its SCO offset, the two devices 10, 30 may be changing SCO offsets at different times and by different amounts and eventually the slot trains for the two piconets 51, 71 should be arranged in such a way that enables data to be transferred between the first and third Bluetooth devices 10, 30.

One of the first or second Bluetooth devices 10, 20 may be a headset, and the other device may function as a mobile radiotelephone or a music player. If the SCO data 9 includes audio data, the first and second Bluetooth devices 10, 20 may compensate for the shifting of the slots allocated to SCO data transfer by storing and delaying the audio data in a local storage device/memory in a first in, first out buffer (FIFO) buffer. The length of the FIFO buffer may be varied by the processors 12 of the first and second Bluetooth devices 10, 20, enabling the devices 10, 20 to compensate for the shifting of the slots by increasing or reducing the amount of audio data stored in the FIFO buffer. In an alternative implementation, the first and second Bluetooth devices 10, 20 may compensate for the shifting of the slots by repeating audio samples, or by deleting the audio samples.

Although embodiments of the present invention have been described in the preceding paragraphs with reference to various examples, it should be appreciated that modifications to the examples given can be made without departing from the scope of the invention as claimed. For example, embodiments of the invention have been described in relation to inquiry or paging data being exchanged by the first and third Bluetooth devices 10, 30. Instead, it may be that the first and third Bluetooth devices 10, 30 are already connected and clock drift in a clock of the first or second piconets 51, 71 causes a connection to break down because there is not enough free slot space to maintain the connection between the first and third Bluetooth devices 10, 20 and the SCO links 50, 70. In this situation, one or both of the Bluetooth devices 10, 30 may be shift the slots allocated to the transfer of SCO data to re-establish the broken connection.

Specific reference has been made above to changing the SCO offset so that the slots that are allocated to transferring SCO data 9 are shifted forwards in time by two slots, or backwards in time by two or four slots. It will be appreciated that these are specific examples and that embodiments of the invention are not intended to be limited to these examples. In practice the SCO offset may be changed so that the slots that are allocated to transferring SCO data 9 are shifted by a different number of slots to those given in the specific examples.

It will also be appreciated by people skilled in the art that while embodiments of the invention have been described with particular reference to Bluetooth, they may also be used in other low power radio frequency technologies.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A device, comprising:
a processor configured to control a low power frequency transceiver to transfer first data between the device and a further device using slots allocated according to a predetermined regular schedule, configured to shift the predetermined regular schedule to free slots previously allocated to transferring first data, and configured to transfer second data using at least one of the freed slots between the device and at least one other device, different to the further device.

2. A device as claimed in claim 1, wherein the extent to which the predetermined regular schedule is shifted is randomly selected.

3. A device as claimed in claim 1, wherein the processor is configured to shift the predetermined regular schedule following an unsuccessful attempt to transfer the second data between the device and the at least one other device.

4. A device as claimed in claim 1, wherein the processor is configured to shift the predetermined regular schedule by at least two slots.

5. A device as claimed in claim 1, wherein the processor is configured to shift the predetermined regular schedule so that the first data is sent using slots at later times than the previously allocated slots.

6. A device as claimed in claim 1, wherein the processor is configured to shift the predetermined regular schedule so that the first data is sent using slots at earlier times than the previously allocated slots.

7. A device as claimed in claim 1, wherein the second data is for establishing a new communication link between the device and the at least one other device.

8. A device as claimed in claim 1, wherein the second data includes data relating to a paging procedure.

9. A device as claimed in claim 1, wherein the transfer of the second data enables the discovery of the at least one other device.

10. A device as claimed in claim 1, wherein the second data includes data relating to an inquiry procedure.

11. A device as claimed in claim 1, wherein the transfer of the second data is for re-establishing a previously existing communication link between the device and the at least one other device.

12. A device as claimed in claim 1, wherein the processor is configured to control the low power radio frequency transceiver to change the predetermined schedule by transferring third data between the device and the further device.

13. A device as claimed in claim 12, wherein the third data includes a request message, requesting the predetermined regular schedule to be changed, and an acceptance message, sent in response to the reception of the request message, accepting the request for the predetermined regular schedule to be changed, wherein the predetermined regular schedule is changed upon reception of the acceptance message.

14. A device as claimed in claim 13, wherein the devices are Bluetooth devices and the request message is an LMP_SCO_link_req protocol data unit and the acceptance message is an LMP_accepted protocol data unit.

15. A device as claimed in claim 1, wherein transferring first data using slots allocated according to a predetermined regular schedule involves determining an offset and an interval.

16. A device as claimed in claim 15, wherein shifting the predetermined regular schedule involves changing the offset from a first offset to a second offset.

17. A device as claimed in claim 1, wherein the devices are Bluetooth devices and the first data is data transferred using a synchronous connection-oriented link between the low power radio frequency device and the further device.

18. A device as claimed in claim 1, wherein the device is a mobile device, and the further device is a headset.

19. A device as claimed in claim 1, wherein the device is configured to operate as a music player, and the further device is a headset.

20. A device, comprising:
means for controlling a low power radio frequency transceiver to transfer first data between the device and a further device using slots allocated according to a predetermined regular schedule;
means for shifting the predetermined regular schedule to free slots previously allocated to transferring first data; and
means for transferring second data using at least one of the freed slots between the device and at least one other device, different to the further device.

21. A method comprising:
transferring first data using slots allocated according to a first predetermined regular schedule;
time shifting the first predetermined regular schedule to create a second predetermined regular schedule; and
transferring second data using at least one slot allocated according to the first predetermined regular schedule but not allocated according to the second predetermined regular schedule.

22. (canceled)

23. (canceled)

24. A method as claimed in claim 21, further comprising randomly selecting the extent to which the first predetermined regular schedule is to be time shifted, and wherein the first predetermined regular schedule is time shifted according to the random selection.

25. A method as claimed in claim 21, further comprising unsuccessfully attempting to transfer second data, and wherein the first predetermined regular schedule is time shifted following the unsuccessful attempt to transfer the second data.

26. A method as claimed in claim 21, wherein the first predetermined regular schedule is time shifted by at least two slots to create the second predetermined regular schedule.

27. A method as claimed in claim 21, wherein the second data is for establishing a new communication link between a device and at least one other device.

28. An article of manufacture, comprising:
a computer readable medium containing computer processor readable code, which when executed by a processor causes the processor to perform:
enabling transfer of first data using slots allocated according to a first predetermined regular schedule;
enabling time shifting of the first predetermined regular schedule to create a second predetermined regular schedule; and
enabling transfer of second data using at least one slot allocated according to the first predetermined regular schedule but not allocated according to the second predetermined regular schedule.

29. An article of manufacture as claimed in claim 28, wherein the computer readable medium further contains computer processor readable code, which when executed by a processor causes the processor to perform randomly selecting the extent to which the first predetermined regular schedule is to be time shifted, and wherein the enabling time shifting of the first predetermined regular schedule to create a second predetermined regular schedule is performed according to the random selection.

30. An article of manufacture as claimed in claim 28, wherein the enabling time shifting of the first predetermined regular schedule to create a second predetermined regular schedule is performed following an unsuccessful attempt to transfer second data between a device and at least one other device.

31. An article of manufacture as claimed in claim 28, wherein the time shifting of the first predetermined regular schedule to create a second predetermined regular schedule occurs by at least two slots.

32. An article of manufacture as claimed in claim 28, wherein the second data is for establishing a new communication link between a device and at least one other device.

33. An apparatus, comprising:
circuitry configured to enable first data to be transferred using slots allocated according to a first predetermined regular schedule, configured to time shift the first predetermined regular schedule to create a second predetermined regular schedule, and configured to enable second data to be transferred using at least one slot allocated according to the first predetermined regular schedule but not allocated according to the second predetermined regular schedule.

34. An apparatus as claimed in claim 33, wherein the apparatus is a chipset.

35. An apparatus as claimed in claim 33, wherein the extent to which the first predetermined regular schedule is time shifted is randomly selected.

36. An apparatus as claimed in claim 33, wherein the circuitry is configured to time shift the first predetermined regular schedule following an unsuccessful attempt to transfer second data.

37. An apparatus as claimed in claim 33, wherein the circuitry is configured to shift the first predetermined regular schedule by at least two slots.
